(19) United States
(12) Patent Application Publication
(10) Pub. No.: US 2007/0226679 A1
(43) Pub. Date: Sep. 27, 2007

(54) Systems, apparatus and methods for distributed deployment management

(75) Inventors: Jay Jayamohan, Fairfax, VA (US); Nicholas G. Parnaby, Vienna, VA (US); Ramana V. Palepu, Oakton, VA (US)

Correspondence Address: RADER FISHMAN & GRAUER PLLC, LION BUILDING, 1233 20TH STREET N.W., SUITE 501, WASHINGTON, DC, 20036, US

(73) Assignee: RollStream, Inc., Fairfax, VA (US)

(21) Appl. No.: 11/702,590

(22) Filed: Feb. 6, 2007

Related U.S. Application Data
(60) Provisional application No. 60/771,433, filed on Feb. 9, 2006.

(51) Int. Cl. G06F 9/44

(52) U.S. Cl. 717/101

(57) ABSTRACT

Systems, method, and apparatus for the definition and management of a deployment program are described. This may entail defining a deployment program having a deployment schedule, participation events, and a plurality of target constituents respectively having defined participation conditions in the deployment program that include at least one participation event in the deployment schedule. Segmentation of the plurality of target constituents is accommodated. In this fashion, sets of one or more target constituents are respectively members of different segments. Segmentation may be dynamic and actionable. Wave-based deployment and provision of a library of reusable deployment templates are also provided.

### CROSS REFERENCE TO RELATED APPLICATIONS

This application claims the benefit under 35 U.S.C. § 119(e) of provisional patent application No. 60/771,433, filed on Feb. 9, 2006 and entitled “Systems, Apparatus and Methods for Rollout Management,” the entire contents of which are hereby incorporated by reference.

### BACKGROUND OF THE INVENTION

This invention relates generally to deployment management, such as for example rollouts and other types of deployments. Some embodiments include a Distributed Deployment Management (DDM) system and corresponding processes and apparatus that allow organizations to manage enterprise technology deployment and/or drive mass adoption of collaborative inter and intra company processes.

Businesses variously deploy new technology programs and process change. However, existing deployment has yet to provide an adequate solution for managing the lifecycle of a major deployment program.

### SUMMARY OF THE INVENTION

Efficient, configurable and effective management of distributed deployments (e.g., deployments referred to as rollouts, or various other deployments) can be accommodated by some or all embodiments of the invention.

According to one embodiment, the definition and management of a deployment program is accommodated. This may entail defining a deployment program having a deployment schedule, participation events, and target constituents respectively having defined participation conditions in the deployment program that include at least one participation event in the deployment schedule. Segmentation of the plurality of target constituents is accommodated. In this fashion, sets of one or more target constituents are respectively members of different segments.

The deployment program may be announced to the target constituents, and the target constituents are engaged to enable an execution of the deployment program. According to one embodiment, execution of the deployment program entails completion of the deployment schedule with the defined participation conditions for respective target constituents differing based upon segment membership.

The segmentation of the target constituents may also be used to provide a wave-based distributed deployment, with an initial segment defining an initial target constituent community that initially completes at least one participation event in the deployment schedule, and at least one successive segment defining successive target constituent communities that subsequently complete at least one participation event in the deployment schedule. This may be done such that an initial segment completes an initial phase of the deployment program, which is then expanded to include additional segments.

Community attribute information may also be used to dynamically define segments, and dictate corresponding actions. The participant community attribute information may be received, for example, based upon deployment owner input to define a segment that may be engaged accordingly. Various examples of receiving community attribute information to dynamically define segments may be provided, including sending queries to target constituents and defining the segment based upon responses. Another example is defining segments according to participant community attribute information such as target constituent company type, name, location, title, participation event completion status, access rights status, technology capability, etc.

Various deployment programs, including but not limited to technology and retail deployments may be managed. The deployment program may also involve a document sharing between the deployment owner and the target constituents, where the segmentation defines access rights corresponding to a document involved in the document sharing.

According to another embodiment, the deployment program and corresponding characteristics may be initially defined from a library of reusable templates. For example, the reusable templates define deployment programs that include one or more of survey materials, training materials, tasks, and documents, and a corresponding deployment schedule, for a particular type of deployment.

According to another embodiment, managing the deployment program comprises receiving a plurality of deployment program indicators to define a deployment schedule and a plurality of participation conditions; receiving a plurality of target constituent indicators, each target constituent indicator from the plurality being associated with a target constituent from a plurality of target constituents; segmenting the plurality of target constituent indicators to produce a first subset of target constituent indicators and a second subset of target constituent indicators, the first subset of target constituent indicators being associated with at least one participation condition from the plurality of participation conditions, the second subset of target constituent indicators being associated with at least one participation condition from the plurality of participation conditions; and sending a message to the plurality of target constituents such that a deployment program is executed based on the deployment schedule, the at least one participation condition associated with the first subset of target constituent indicators and the at least one participation condition associated with the second subset of target constituent indicators.

According to still another embodiment, managing the deployment program comprises receiving a plurality of deployment program indicators to define a deployment schedule, a plurality of participation events and a plurality of participation conditions; receiving a plurality of target constituent indicators, each target constituent indicator from the plurality of target constituent indicators being associated with a target constituent from a plurality of target constituents; sending a message at a first time to a first subset of target constituents from the plurality of target constituents based on at least one participation condition from the plurality of participation events and associated with the first subset of target constituents; receiving a message from the first subset of target constituents indicating that a first participation event from the plurality of participation events has been completed based on a deployment schedule; sending a message at a second time to a second subset of target constituents from the plurality of target constituents based on at least one participation condition from the plurality of participation events and associated with the second subset of target constituents; and receiving a message from the second subset of target constituents indicating that a second participation event from the plurality of participation events has been completed based on the deployment schedule.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the embodiments are more fully disclosed in the following detailed description, reference being had to the accompanying drawings, in which:

FIG. 1 is a flow diagram illustrating a Setup Deployment Program process in accordance with an embodiment of invention.

FIG. 2 is a flow diagram illustrating an Execute a Deployment Campaign process in accordance with an embodiment of invention.

FIG. 3 is a flow diagram illustrating an Executive Dashboard process in accordance with an embodiment of invention.

FIG. 4 is a block diagram illustrating an DDM System overview in accordance with an embodiment of invention.

FIG. 5 is a display diagram illustrating an example of a user interface for adding a contact.

FIG. 6 is a display diagram illustrating an example of a user interface for creating a new program.

FIG. 7 is a display diagram illustrating an example of a user interface for creating and editing a survey.

FIG. 8 is a display diagram illustrating an example of a user interface for adding a new training and education unit.

FIG. 9 is a display diagram illustrating an example of an executive dashboard user interface.

FIG. 10 is a display diagram illustrating an example of an executive dashboard user interface with further illustration of key statistics.

FIG. 11 is a display diagram illustrating an example of a user interface where the briefcase is selected within the executive dashboard category.

FIG. 12 is a block diagram illustrating an example of the software system architecture for the DDM System.

FIG. 13 is a block diagram illustrating an example of DDM module.

FIG. 14 is a diagram illustrating an overview of a deployment lifecycle.

FIG. 15 is a diagram illustrating an example of document sharing.

### DETAILED DESCRIPTION

In the following description, for purposes of explanation, numerous details are set forth, such as flowcharts and system configurations, to provide an understanding of one or more embodiments of the invention. However, it is and will be apparent to one skilled in the art that these specific details are not required in order to practice the embodiments of the present invention.

One or more embodiments provide a distributed deployment management (DDM) system and corresponding processes and apparatus that allow organizations to manage enterprise technology rollouts (or other deployments) and drive mass adoption of collaborative business-to-business processes.

The DDM System can be for example a software-based platform that facilitates well organized completion of deployments, particularly large scale one-to-many type deployments. Deployments in any number of industry applications are accommodated including but not limited to Retail, Defense, Financial Services, Healthcare, and Energy.

Particular examples include deployment to the mobile and distributed workforce, deployment of emerging technology to multiple stores or other places of commerce, rapid deployment of software or other new technology, or adoption of new technology, standards or procedures to global trading partners.

In one embodiment, the DDM system facilitates relationship between a Deployment Owner (DO) and Target Constituent (TC). The DO and TCs for a given deployment are able to provide the various functions related to deployment, and manage a deployment database to facilitate the provided functions, and facilitate the provision of reports and related progress regarding a deployment.

The DO uses the DDM system to set up the program, goals, constituents and plan for completing the deployment. The program may then be collaboratively launched with the TCs, with the DO able to continually manage and monitor the TCs through the DDM system. TCs are enrolled and engaged with the deployment process through the DDM system, which may include collection of necessary information, completion of educational courses and surveys, and other tasks deemed necessary for a successful deployment. The TCs are also able to report real-time progress to the DO through the common platform, and may further communicate and network with TC peers to further a successful and more efficient deployment.

According to another aspect, in connection with defining a deployment, the DDM system may also use previously established industry (or rollout or other deployment type) specific content packages useful for acceleration of deployment management. These content packages may be standardized but also may be customizable to meet the needs of specific applications. The specific content packages are imported into a new program in the form of content templates. By way of example, the content templates for a particular content package may include:

i. Best practice milestone templates for industry vertical and horizontal programs;

ii. Training, educational or assessment content to assist in deployment execution;

iii. Surveys and data collection tools to help the user execute;

iv. Reports and dashboards that enable easy management of program and reporting; and

v. Wizards that enable the user to customize the template to their specific situation.

In one implementation, deployment management comprises interfacing with a DO participant to define a deployment program to have characteristics including an execution schedule and a corresponding set of objectives and to define at least one TC community for the deployment program. The TC community can include multiple TC participants that participate in the deployment program. This participation may include completing a survey, completing an educational session, and/or completing a milestone event. Deployment management also can engage the TC participants and the DO participant to execute the deployment program, and report progress relating to the deployment program.

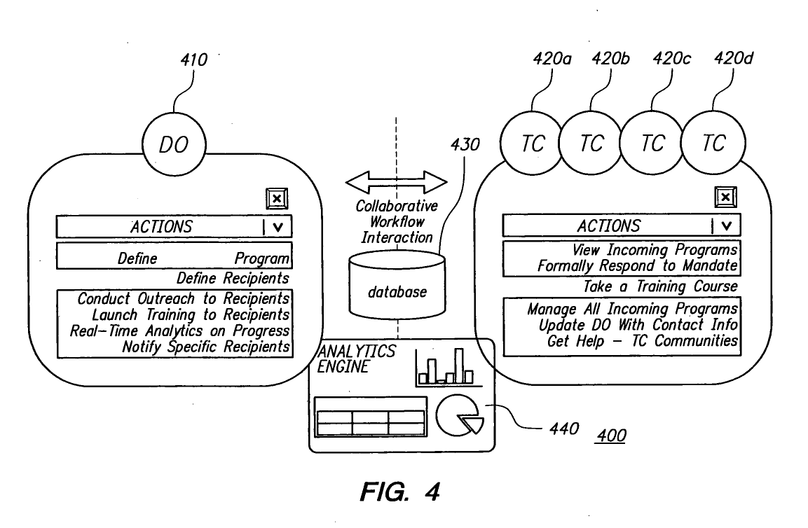

FIG. 4 is a block diagram that gives an overview of the functionality of an embodiment of a DDM System 400 and corresponding collaborative workflow interaction by DO 410 and TC(s) 420a-d. In one example, the DO may also be referred to as a HUB and the TCs may also be referred to as SPOKEs, although embodiments are not limited to situations where the DO and TC are respectively named HUB and SPOKE, and corresponding communications described in connection with embodiments of the present invention are not limited to those use a hub/spoke architecture or methodology. For example, in alternative embodiments, the functionality of the DO can be distributed across multiple locations or platforms. In other embodiments, this functionality can be distributed among the TC participants via pier-to-pier communications.

In one embodiment, the DDM System 400 comprises a software-based platform that facilitates well organized completion of deployments, particularly large scale one-to-many type deployments. The DDM System 400 may accommodate such deployments in any number of industry applications including but not limited to Retail, Defense, Financial Services, Healthcare, and Energy. Particular examples include deployment to the mobile and distributed workforce, managing the alignment of a project or a specific business process that occurs between a business and its trading partner suppliers and distributors, deployment of emerging technology to multiple franchises, retail outlets or stores (e.g., retail/franchise) or other places of commerce, rapid deployment of software or other new technology, or adoption of new technology, standards or procedures to global trading partners.

The DDM System 400 interfaces with a DO 410 and TC 420a-d, which are able to interact and communicate through a common platform provided by the DDM System 400 to variously facilitate the deployment. The DO 410 may also be referred to as the deployment program owner, and the TCs 420a-d as the deployment program targeted participants/constituents. The DDM System 400 includes software for implementing and executing the various functions related to deployment described below. The DDM System 400 also implements and manages a Deployment Database 430 to facilitate the provided functions as described below, and includes an Analytics Engine 440 that facilitates the provision of reports and related progress regarding a deployment.

The DO 410 uses the DDM System 400 to set up the deployment program, including the goals, constituents and plan for completing the deployment. The program may then be collaboratively launched with the TCs 420a-d, with the DO 410 able to continually or intermittently manage and monitor the TCs 420a-d through the DDM System 400. TCs 420a-d are enrolled and engaged with the deployment process through the DDM System 400, which may include collection of necessary information, completion of educational courses and surveys, and other tasks deemed necessary for a successful deployment. The TCs 420a-d are also able to report real-time progress to the DO 410 through the common platform, and may further communicate and network with TC 420a-d peers to further a successful and more efficient deployment.

The DDM System 400 implements various processes to create and define a deployment program, execute outreach programs within the deployment program, and measure and report progress.

The DDM System 400 provides a user interface and corresponding integrated provision of educational and training, constituent relationship/process management, and survey (web form data capture) tools for providing the functionality described further below. The DDM System 400 may interface with any number of applications to accommodate the described individual functions provided in the umbrella of services managed by the DDM System 400. These applications may include a Learning Management System (LMS), Customer Relationship Management (CRM), Survey Analysis systems, as provided by RollStream, of Fairfax, Va. These are just examples of the applications that may be used to accommodate these functions. Other applications may be used as a substitute, or to provide additional features in connection with deployment management. For example, industry specific workflow and database applications may be provided in an integrated fashion through the DDM System 400.

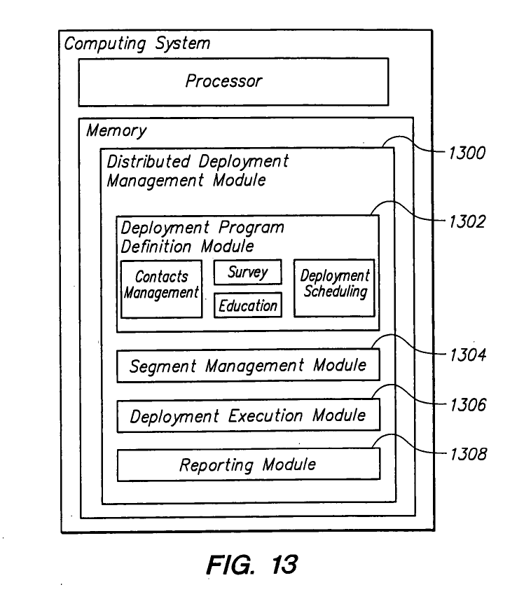

FIG. 13 is a block diagram illustrating an example of DDM module 1300. The DDM module 1300 can be provided as software that executes on any conventional computing platform to provide the described functionality of distributed deployment management.

The DDM module 1300 also can be part of a DDM System and accommodate interfacing with one or more DO parties seeking to create and/or manage a deployment, and corresponding TCs, through a network connection such as through the Internet. In such embodiments, access to the DDM System and corresponding interfacing may be made using conventional computers equipped with browsing capability. If desired, the TC and DO clients may be merely equipped with browsing capability with the full functionality provided by the DDM System through the Internet connection. Alternatively, the browsers may be equipped with plug-ins or the TC and DO client computers may be similarly equipped with software used in association with the DDM System functionality.

Although a modular breakdown of the DDM module 1300 is described, it should be understood that the described functionality may be provided with fewer, greater, or differently named modules. Here, the DDM module 1300 includes a deployment program definition module 1302, segment management module 1304, a deployment execution module 1306, and a reporting module 1308.

The deployment program definition module 1302 includes contacts management, survey, and education modules. These modules respectively allow the DO to configure surveys, training and education, and to manage contacts pursuant to setting up and announcing a deployment as described herein. The deployment scheduling module accommodates the configuration of the deployment schedule for a deployment being configured by the DO. A variety of milestones may be associated with a given deployment, and these milestones may be generally managed by a calendaring function of the DDM module 1300.

A variety of participation events may correspond to a deployment schedule, including acknowledgement of the announcement of the deployment, completion of a survey, completion of education or training, or meeting any goal defined to be such an event according to the configuration of the deployment. TCs have defined participation conditions in the deployment program, with the participation conditions including one or more participation events in the deployment schedule. For example, a first TC for an organization may be responsible for acknowledging the deployment, and another TC may be responsive for responding to and taking a training course, among other participation events, and so on. The deployment program definition module 1302 is thusly configured to allow the DO to define a deployment program having characteristics including a deployment schedule, corresponding participation events, and a plurality of TCs respectively being associated with participation conditions in the deployment program that include at least one participation event in the deployment schedule.

The segment management module 1304 is configured to accommodate segmentation of the TCs, such that sets of one or more TCs are respectively members of different segments. This allows the participation conditions for the deployment program and corresponding schedule to be directed at appropriate segments of the TC population.

The deployment execution module 1306 is in communication with the deployment program definition module 1302 and the segment management module 1304, and is generally configured to carry out the execution of the deployment as previously defined. In that regard, the deployment execution module 1306 announces the deployment to the target constituents, and engages with the target constituents to enable an execution of the deployment program. The execution of the deployment program preferably includes completion of the deployment schedule with the defined participation conditions for respective target constituents differing based upon segment membership. That is, it is ensured that appropriate TCs, according to the segment(s) to which they belong, are tasked with certain participation events (acknowledgement, training, document access, etc.). In this regard, the deployment execution module 1306 accesses the deployment schedule, segment membership information, and corresponding communication facilities (e.g., e-mail, etc.) to accommodate completion of the deployment schedule.

The segmentation and corresponding execution of the deployment program may also provide a wave-based distributed deployment, with an initial segment defining an initial target constituent community that initially completes at least one participation event in the deployment schedule, and at least one successive segment defining successive target constituent communities that subsequently complete at least one participation event in the deployment schedule. This wave-based distributed deployment may be useful both within a given deployment program generally, and particularly for those types of deployments that occur in phases. For example, a complicated rollout may have several milestones, starting with an acknowledgement, continuing with various intermediate events, and culminating with a completion of a goal. For such a deployment, it may be desirable to have an initial enrollment and engagement with a first group of TCs, followed by an expansion of the deployment to other groups of TCs. In that regard, announcing the deployment to the plurality of target constituents comprises initially announcing the deployment to target constituents in the initial segment and subsequently announcing the deployment to target constituents in the at least one successive segment.

Still further, the segmentation and corresponding execution of the deployment program are dynamic and actionable. Generally, this means that the DO may variously define the constituency of a given segment based upon the attributes that a TC might have, and then prescribe a corresponding action. The segment management module 1304 is thus further configured to receive participant community attribute information, and then define a particular segment of the plurality of target constituents based upon the received participant community attribute information. The deployment execution module 1306 then engages with the particular segment of the plurality of target constituents to further the execution of the deployment program accordingly.

A variety of information and attributes may be used to dynamically define a segment. For example, a query related to completion of a selected participation event in the deployment schedule may be received from the DO (e.g., which TCs have acknowledged the announcement, which TCs have completed training, which TCs have completed a combination of events, etc.). The particular segment is then defined as those target constituents that have not yet completed the selected participation event.

Additionally, various community attribute information is searchable to accommodate the segmentation. Examples of participant community attribute information include but are not limited to target constituent company type, name, location, title, participation event completion status, access rights status, technology capability, and others described herein.

Still further, a response to a survey question may be used to tailor a given segment defined as those TCs that indicate a given response to the survey question. The DDM system also variously facilitates finalizing and saving segments. The searches/segments can later be retrieved and used with the associated distribution list to set up a new deployment, announcement or communication.

By way of example, assume the DO wants to launch a targeted deployment to all their suppliers based in California that they do at least $1 m in business with and also only those suppliers who are able to support a particular kind of electronic transaction called EDI850. The deployment in this instance is a legal education program where the TCs must review some educational materials then respond via a web survey. The DO performs a contact search for all suppliers, then selects filters/operators including EDI850 (True), Sales Revenue $1 m or greater. The DDM system returns the required search and provides the option to save it. The saved search can be private to the particular DO or available to all DO people on the deployment. Then the DO can retrieve the search and perform several actions on it, such as creation of a new deployment using the searched TC audience, or exporting the TC attribute/contact data for use elsewhere. When the DO uses the search to create a deployment or communications campaign to the TCs, the DO can also include the education content and web survey within the communication so the TC can take them from within an email or private portal.

According to another aspect, the deployment program may involve document sharing, wherein the deployment program is a document sharing between the deployment owner and the plurality of target constituents, and the segmentation defines access rights corresponding to a document involved in the document sharing. This, for example, may be used to ensure that a party can only access a document according to configurable restrictions. This may involve limiting the party to certain levels of access. For example, some TCs (as defined by their segment), may only be allowed to read a document, whereas others may edit all or a portion of the document. Additionally, a document may be partitioned for viewing, with the segmentation dictating which portions of the document can be viewed, such that a first TC can view only a first portion of the document, and a second TC can view only a second portion of the document. This may be useful where different segments need to (or should) see and/or edit only desired portions of a document, which is believed useful in various business and legal settings.

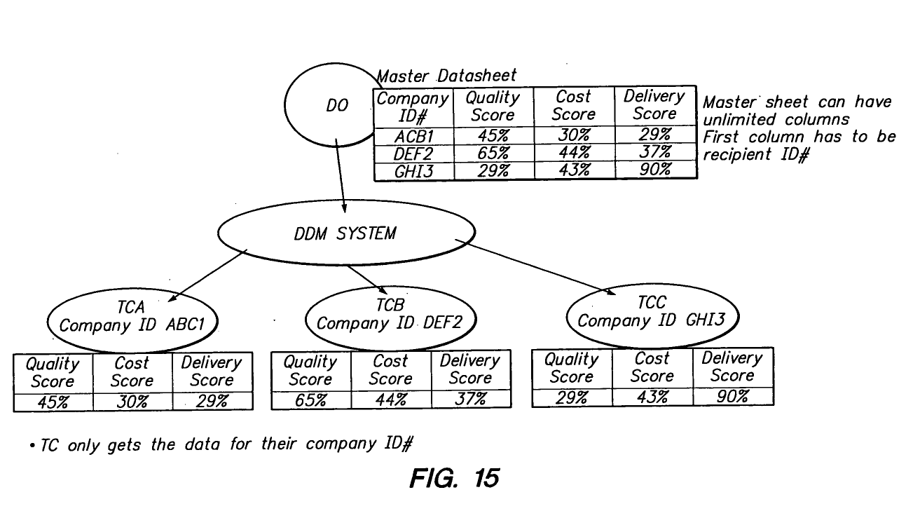

FIG. 15 illustrates an example of document sharing. The DDM System enables engagement or continuous deployments from DO to TCs where the DO wishes to share TC-specific content. The document sharing aspect allows a DO to upload a master data sheet or content file to the DDM System, where the individual TCs are denoted using an ID# or primary key. Using this information, the DDM System partitions the master data into its TC-specific components and shares it with the TCs individually. The DDM System allows content to be shared routinely such as on an hourly, daily, weekly, monthly or periodic basis. In one example, the shared information may be a spreadsheet of performance and scorecard data, for communication to suppliers to convey how they are performing. With the DDM System, the DO does not have to send 1,000 individual emails to 1,000 suppliers. One sheet is uploaded and then shared securely and privately.

For example, a supermarket company DO may be measuring the on-time performance of suppliers and how often they miss their scheduled delivery dates and times. Assume that they want to share this data weekly with the suppliers, but that there are over 4,000 of them. The DDM System allows one person to upload the data and then the system will partition it and present it to each TC (Supplier) with their own on time delivery score. This can be done periodically, and a history can be maintained in the system for trending and monitoring of TC improvement or degradation of delivery performance. If desired the TC and DO can both download and manipulate the data, and then upload the data to the DDM System to collaborate on the content within the data sheet, keeping version control and history.

Still referring to FIG. 13, according to another aspect, the deployment program and corresponding characteristics may be defined from a library of reusable templates as introduced above. The reusable templates define deployment programs that include one or more of survey materials, training materials, tasks, and documents, and a corresponding deployment schedule. This allows a refined and successful deployment program to be carried over to a similar deployment, without requiring the DO to create the deployment completely. It also retains flexibility as the DO may use the template as a starting point, and then customize the deployment program according to the particular needs and conditions of the given new deployment.

By way of example, assume the DO wants to deploy RFID technology across their supply chain to trading partners. The DO may want every supplier to put a tracking ‘chip’ on every case and pallet of goods shipped to them so they can trace these items across the supply chain without bar codes, using remote frequency technology, and the DO can read the entire contents of a truck of these without a line of sight, using an RFID reader for example. The challenge is that the DO needs to deploy this to their TCs (suppliers or distributors). The DDM System provides a template for RFID Pallet/Case Deployment. The template may include: (1) a best practice RFID Deployment task plan for each supplier (loaded in as milestones/events; (2) previously prepared letters that can be used to launch the program to the suppliers during the announcement phase; (3) education programs to bring the suppliers up to speed on the new technology/process; (4) a readiness survey that can be used to assess the capabilities and readiness of all suppliers—with best practice questions to ask to test their receptiveness, readiness and ability to meet the DO deployment requirements; and (5) a reporting template for measuring supplier (TC) response.

Finally, the DDM module 1300 includes the reporting module 1308, which provides reporting and analytics functionality as variously described herein. The reporting includes providing analytics corresponding to completion of the defined participation for the plurality of target participants as a group and for subsets of the plurality of target participants.

The DO is allowed to constantly monitor the progress of their deployment from the moment of launch, and to react to the deployment in different ways, depending upon TC activity and response. The reporting functionality, which may be referred to as a dashboard, enables this monitoring and visibility into the activities and behaviors of the TCs. Useful areas of reporting include (1) Reporting on TC task completion. This may include # responded, # not, number targeted, # activated with an email letter #who are implementing the tasks assigned, # who have completed the tasks, detailed breakdown of which TCs have completed which tasks, etc. These are based on the fact that the TC is able to provide their status vis-à-vis the tasks on their own collaborative dashboard. Other areas include (2) Reporting on the surveys and web forms completed by one or many TCs; (3) Reporting on the learning and multimedia content delivered from DO to TCs (e.g., who has opened/taken it, when, for how long, did they score a pass or fail if an assessment, what score achieved was); and (4) Reporting on TC activity on the system (e.g., who logged in, when, for how long, last time they logged it, etc.). The other useful aspect of the reporting functionality is the ability for the DO to act on the results of these reports and jump immediately to a deployment objective-oriented activity based on the reporting numbers.

By way of example, suppose the DO launches a task plan to 100 TCs with an educational overview and then a feedback survey. The DO looks at the dashboard and can see that of the 100 contacted, 35 have responded and begin the task list, 65 have not. Of the 35, 10 are still implementing and 15 are completed. The individual task status is also displayed. The DO can use the DDM System reporting functionality to select any of these statistics and a) View who is at each stage, b) Email only that segment of TCs who are represented on that report, c) Send a campaign that could include one or more of education, surveys, more tasks or informational content to any one of the sub audiences represented don the reports, or d) Export the contact details for that TC segment. Also, the survey may ask additional questions such as “Would you like to see a video on our product?” and 28 click YES and 7 click no. The system lets the DO click on an “action” button or the like near the 28 who responded “YES” and creates a sub-deployment to them.

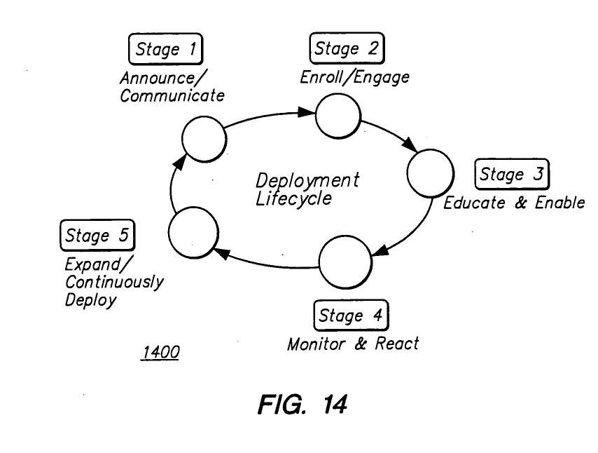

FIG. 14 is a diagram illustrating an overview of a deployment lifecycle 1400. A deployment may be an undertaking that occurs between a Deployment Program Owner (DO) and one or many Targeted Constituents (TCs). It can be a continuous deployment or a project or program based deployment. Deployments include technology, process, standards or inter and intra business process alignments. In the Announce and Communicate Phase 1, the DO launches a deployment or a particular phase of a deployment with an announcement communication. This communication may be one of many continuous deployment related communications. In the Enroll and Engage Phase 2, the DO can enroll the TCs into the program and ensure they are onboard and listening. The DO can engage the TCs in multiple ways as described herein, including via email, fax, letter or within a private community setting. This engagement is aimed at ensuring that the TC community is in alignment with the DO desire to deploy a process, technology, standard or practice. In the Education and Training Phase 3, the DO can educate the TCs with respect to the deployment and can also provide education specific to tasks or milestones that the TCs must complete. Under this phase, the DO may also provide the TCs with any processes, procedures, and that enables the TCs to move towards the deployment goals. In the Monitor and React Phase 4, the DO assesses progress, results and reports on how the deployment is going and how the TCs are reacting. Based upon the results of this, the DO will react in order to maintain momentum, fix issues or adjust approach to the overall deployment of a specific deployment task or activity. Finally, in the Expand/Continuously Deploy Phase 5, the DO expands the deployment if the initial stages were a pilot or proof of concept or to a limited number of TCs. If the deployment is to be a continuous process or relationship between the DO and TCs, then this phase also addresses the long term aspects of the deployment to align processes and practices between DO and TCs on an going basis.

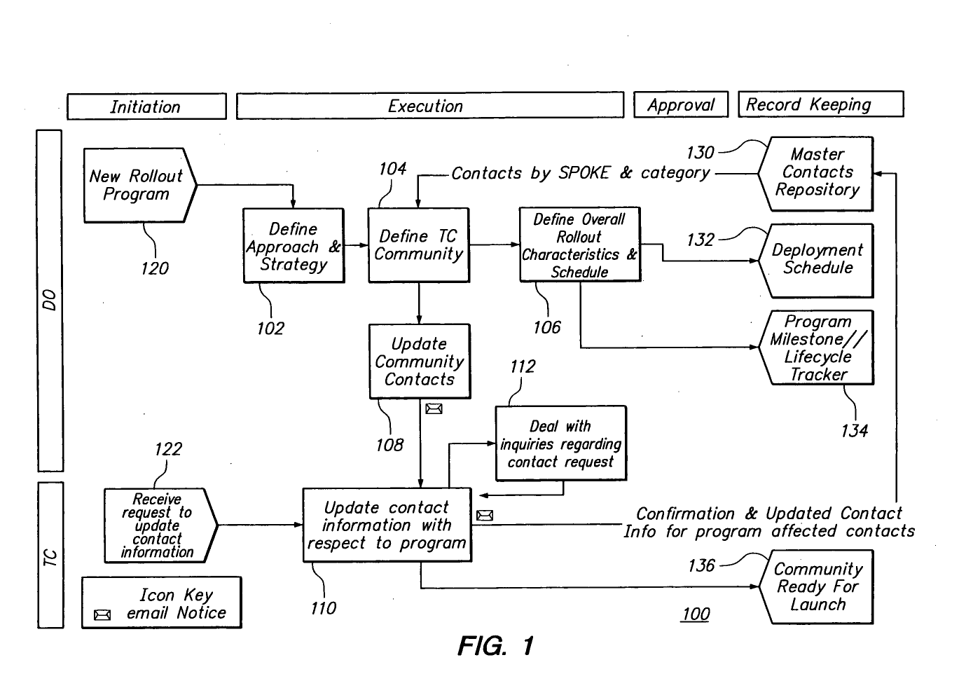

The flow corresponding to the initialization, engagement, and execution of the deployment program is further described with reference to FIGS. 1-3. FIG. 1 is a flow diagram illustrating an example of the Setup Deployment Program process 100 facilitated by the DDM System. At the beginning of any deployment program, the DO is tasked with defining their program and a deployment strategy for rolling it out. The DO is able to use the DDM System to clearly define their targeted audience/constituents (TCs). This audience targeting allows for the building of the target audience based upon a number of criteria held within the deployment database. Audience selection can be driven, for example, by the type of person or company and/or the functional role of the targeted people in scope, and/or a number of other definable criteria. For example, a DO may decide to perform a search of the deployment database for all companies that supply them with cosmetic goods, and then only display those companies within this that sell at least $1 m of goods, and further refine the search criteria to include only those companies within the state of California. The results of this search within the deployment database would deliver to the DO a target audience of constituents for a particular deployment program. After the DO has determined the major areas and the constituents (TCs) within their program, the DDM System defines the deployment program, its major areas of focus and stages, the TCs or groups/categories of TCs they would like to deploy the program to and the DO also has the option of also defining the key milestones/tasks and stages of maturity they view as part of program completion, which can be tracked via the DDM System Executive Dashboard.

As indicated, the DO and TCs have roles in the Setup Deployment Program process, which may be divided into Initiation, Execution, Approval, and Record Keeping components or phases. FIG. 1 illustrates processes useful for carrying out the Setup Deployment Program process 100, including Define Deployment Approach & Strategy 102, Define TC Community 104, Define Overall Deployment Characteristics & Schedule 106, Update Community Contacts 108, Update contact information with respect to program 110, and Deal with inquiries regarding contact request 112.

A triggering event for the initiation of the Setup Deployment Program process 100 is a request for a new deployment program (120). Following such a request, the DO needs to setup and run a new deployment program. Another event is a received Request to Update Contact Information (122), wherein TC receives a request to create, update or confirm their contact information associated with the deployment, and can respond to this request directly within the deployment system—providing contact data which will be added to the DO central deployment database.

Aspects of Define Deployment Approach & Strategy 102 may often be accommodated offline (e.g., independently or with the assistance of account services staff). These deployment approach and strategy may also be based upon the described reusable templates, which may be accessed online if desired. Regardless, the DO defines the general approach to the program including aspects such as size, scope, timing, and sequencing of TC deployment. Once the key aspects of the program have been defined, the DDM System captures the profile of the program against key criteria. This profile provides an overview that enables users to understand key aspects of the program, its objectives and criteria for success.

In Define TC Community 104, the DO defines the desired deployment community. For an outreach to be effective, the DO can use the most up-to-date information for the key personnel at the TC—this can be one or many individuals per TC company or entity. The DO uses this functionality on an ongoing stand alone basis (see step 108 below). In many cases, the DO may provide the DDM System with a raw contact list. If desired, the DDM System may invoke externally provided contact cleaning services to obtain clean, current and comprehensive contact data, as well as assist in the formatting of the data to enable grouping of contacts by category/hierarchy type or to assist in recording to which attribute sets the contact or company belongs. This formatting enables the unique audience search and select features provided for Deployment Approach & Strategy 102 as well as finely targeted communications. Each TC may be asked to confirm and provide current contact information before commencing with an outreach campaign. During this process, the DO groups TCs against a hierarchy, so that communities of TCs can be created. TCs can be targeted for campaigns based on different selection criteria based on types, attributes and waves such as revenue, SKUs, geography etc. For example, a retailer may want to deploy a collaboration program to its drug suppliers first and also sub-segment out the drug suppliers into over-the-counter versus the pharmacy/Rx suppliers. The system will also permit the DO to refine their audience by other key characteristics (e.g., size of company, number of employees, computing and information technology capabilities, temperament, number of product items sold or geographical location). The DO can save such criteria within the system in order to facilitate the phasing of their deployment/rollout into a series of ‘waves’.

At the completion of the Define Overall Deployment Characteristics & Schedule step 106, the significant features of the program will have been defined as described in connection with step 102 above. To track progress of the program in an effective manner, the DO now creates a program lifecycle and key milestones profile upon which to track each TC. Additionally, an overall schedule is defined, upon which to measure program progress. The DO uses the DDM System to define these and store them in the system.

Creation of a milestones (participation events) may be a ‘blank sheet of paper’ exercise, but may also be done by downloading ‘templates’ that provide the DO with classic milestones that have been used in best practice program deployments for the program area of specialization. For example, in a retail example this may include milestones such as a) Supplier Has Received DO (Retailer) mandate, b) Supplier Has Confirmed program participation, c) Completed GTIN/GLN Allocation, d) Initial Catalog Load Complete, e) Joined Global Registry, etc.

Other examples of participation events might be for an employee at a company to a) Confirm they have received a particular document or file, b) Download the file and added content to it, c) Upload the revised file to the system, d) Complete a satisfaction survey, e) Mail their survey to the DO and e) Provide a tracking number from FedEX to the DO so the DO can track the package sent.

The Update Community Contacts 108 step entails DO refinement of TC contact information. The DO may invoke the Contact Cleaning Services for assistance in this regard. The DDM System provides the ability to send a request for contact information electronically or for users to log in and update themselves. Additionally, a capability for the DDM System to periodically poll a TC in a secure and no-spam manner can be used to retrieve the most current contact information.

Updating 10 contact information with respect to program entails ongoing updates to the contact information during the course of the program. On receipt of request, or voluntarily, the TC will provide updates to their contact and program organization information.

Inquires may also be received and handled (Step 112) regarding contact request. Here, the system handles inquires such as situations where the TC is concerned regarding the request for their contact information or would like to ask for information prior to updating. The system provides a form and e-mail based communication to clarify the DO requirements so that the TC can then proceed and update their contact information.

The DDM System also facilitates provision of the following Results (End States), Repositories & Reports in connection with the Setup Deployment Program process.

The Master Contracts Repository 130 provides the database of all TC contacts. The Deployment Schedule 132 is the database for storing program schedule information and relation to TCs/groups and key program milestones. The Deployment Program Lifecycle/Milestone Tracker 134 is a list of key program milestones upon which to base progress monitoring and the Executive Dashboard views, and the TC/Community Ready for Launch indicator 136 provides indication that, after updating contact information successfully, the TC is ready to accept the deployment program when the DO launches it.

The functionality of the DDM System in conjunction with steps introduced above is further described as follows.

Define Deployment Approach and Strategy (102) entails capture of a living profile of the program in a web form view with freeform text fields, with ability to view the profile such as from a file/programs/profiles menu. Profile fields include:
Program Name (up to 100 Characters)
Program Objectives (up to 500 characters)
Program Description (Up to 2500 characters)
Launch Date (completed automatically when program is launched later)
Completion Target date (completed and calculated automatically upon launch and then schedule definition)
Program Owner Name (Up to 50 Characters)
Program Owner Title (Up to 100 Characters)
Program Owner Department (Up to 50 Characters)

The DDM System also accommodates profile configuration for all DO resources that will be permitted to use the DDM System and the various permissions associated with system usage. The DDM System supports and allows at least ten DO resources to work on the program, and typically more. An example of the information regarding the program resources to be captured follows:
DO Resource Name (Up to 50 Characters)
DO Resource Title (Up to 100 Characters)
DO Resource Department (Up to 100 Characters or select from a definable drop down list of all departments, to standardize around shared terms)
DO Resource description of role on the program (Up to 500 characters)
Permission levels (Drop Down lists or radio buttons to pick or apply more than 1 permission)
Administrator
Operator
Other

Define TC Community (104): The DDM System allows a DO to announce to contacts that are loaded into the system that they will be taking part in a deployment program (preferably by an e-mail announcement with text customizable by the DO). The announcement is sent by group email and provides the TC(s) with a setup instruction that enables the TC to define an account on the DDM System for that DO program. Preferably, establishment of this account allows not only the interaction with the DO as set forth in the announcement, but also extension into any number of other programs with the same or other HUBs. The account setup captures general contact and classification information and then the specific information required by the DO.

The DDM System allows each TC to save their profile (the general portion) before continuing with the specific DO program setup. Password protection on the account can be provided, with a password reset by email functionality if the DO or TC forgets or loses a user name and/or password.

The DDM System accommodates definition of all the fields required for a TC contact and captures them in a living, extensible repository. A request is sent by the DO to the TC(s) via email. This request contains an HTML form that can be completed from within the e-mail and submitted using a button within the email. For recipients unable to accept HTML emails, an instruction with a URL to visit that takes them to a form where the information can be inputted may be provided. The fields required include:
TC_Company_Name
TC_Last_Name
TC_First_Name
TC_Job_Title
TC_Address_Line_1
TC_Address_Line_2
TC_City_Name
TC_State_Region (Drop down list of all USA states and also an “Outside USA” option where the user can select and then enter their state/region in freeform (to 50 characters)
TC_Zip_Postal_Code (To 10 characters)

The DDM System also allows the DO to customize the names of standardized fields in the contact database to make the program more specific to the usage. For example, the TC_Company_Name field might be labeled with an alias such as “Supplier Company Name”.

The DDM System allows each TC to classify themselves against a defined category or grouping area, as defined by the DO, so that when they have finished entering basic contact information the TC can address some key questions (by selecting from drop down boxes) regarding their characteristics. Fields to capture include:
TC Company Type (select from drop down list defined by the DO)
TC Company Size In Revenues (select from a Range drop box defined by DO)
Up to 8 other fields that can be specified by the DO to appear in drop down boxes or listed as several radio buttons or check boxes that can be checked to indicate a selection

Finally, the DDM System allows the DO to make classification lists by area whilst developing their TC community definition—to enable TC(s) to categorize themselves per the above points.

The Define Overall Deployment Characteristics & Schedule step (106) allows the particulars of the program to be defined. In order to track and measure the progress and success of a program, the DO works within their DDM System account to create an overall profile of the program. This may be accommodated directly through access to the DDM System, with external support if desired.

The DDM System accommodates definition of all the key milestones within a program that the TC will go through in order to complete their deployment with the DO. Preferably, these milestones are created by the DO and then converted to a lookup table that can be used to track TC progress. Default milestones are provided according to industry or application. For example, a suggested set of milestones for a Retailer to use in a Data Synchronization deployment program already loaded into the system, or for a generic RFID deployment program. The milestone descriptions can be edited from the pre-defined templates or a fully customized set of milestones can be created from scratch. By way of example, milestones for Global Data Synchronization (GDS) and RFID (which can be edited/configured) are provided as follows:

GDS Milestones:
Confirmed TC's contact information in support of deployment program
TC has been sent a mandate or notification that they are required to respond
TC has responded (Positively or Negatively) to mandate/request
TC understands DO requirements for deployment
TC has performed data cleansing and allocation of GTIN/GLN/TM standards
TC has performed initial load and is testing with a GDSN Certified Data Pool
TC in production live with GDSN Data Pool and ready to synchronize with DO

RFID Milestones:
Confirmed TC's contact information in support of deployment program
TC has been sent a mandate or notification that they are required to respond
TC has responded (Positively or Negatively) to mandate/request
TC understands DO requirements for deployment
TC selected technology and/or systems integration vendor
TC member of EPC global
TC implementing Case/Pallet level tagging
TC ready to ship tagged product to DO DC

Another aspect of the deployment program that the DO may define is the use of surveys. For example, the DDM System allows the DO to conduct surveys within their defined TC communities that can be used to help plan realistic deployment planning. For example, a retailer may desire to deployment to all suppliers in all segments, prioritizing by size of volume they do with the supplier. However, based on a readiness survey with the survey results that can be linked to the TC (supplier) contact and categorization details, they may decide to adjust their deployment approach. The adjustments could be automated or manual based on the responses captured from the survey response.

An example of this is as follows. The DO delivers a readiness assessment to a group of TCs. An assessment question asks what kind of computer system and software the TC has. Based upon the responses of the TC, the DO may decide to deploy their first phase of the program only to those who responded that they have a particular computer hardware or software configuration. The DO may decide only to deploy to this sub-segment of the TC constituent audience. The system will a) deliver this information on aggregate for the DO to view in real-time as it is provided by the TCs, and b) uniquely allow the DO to ‘act’ on the results of the web form survey and automate the creation of a distribution/email list for only those TCs who responded to a particular survey question in a particular manner. In b), when the DO acts on the results, the system automates the creation of the new program or communications campaign to that sub-segment of the total constituent audience

The DDM System also implements the optional setting up of a schedule for the program and attaching TCs and groups of TCs to the overall timeline—the DO creates a master program schedule and lists out the dates by which they plan to have rolled out their program to the TCs. For example, a Retailer may have 4,000 suppliers in total to roll out the GDS program to—however, they may decide to roll out the program to the food/grocery category of suppliers first (of which there may be 850) and then they may only have a capacity for them to introduce 50 additional per month. The deployment schedule is used to help the retailer model their planned schedule against their capacity and the groups of suppliers who have indicated that they are ready within the timescales required to meet the deadlines to roll out.

Other functionality in this category includes the ability for the DO to model the universe of TCs that will be rolled out to and then add them to the overall schedule, and the ability for the schedule to dynamically change with respect to the number of TCs entered. Milestones and sub-milestones can be created and stored as templates that can in turn be retrieved for later use in repeatable programs. These templates may be edited and customized to create new templates. Also included is accommodation for setting different target dates for different TCs, although the same milestone template may be used for all the TCs in a program/campaign. Milestones can be designated for alerts to the DO and the corresponding TCs should the target date be missed by a TC.

The Update Community Contacts step (108) is as follows. The DDM System accommodates login and manual entry and update of contacts according to the DO permissions. The DDM System also allows the DO to import contacts from another system, spreadsheet or text file format, with appropriate data mapping that enables the DO to map source attributes to the target attributes in the DDM System. The DDM System also allows the DO to use a ‘public’ database of contacts for (e.g., suppliers') initial contact information. For example, if the DO is not the first Retailer to deploy RFID to a group of suppliers, there will already be contact information for those suppliers in a public database. The retailer simply imports that contact information from the ‘public’ database and then links it to a ‘private’ set of attributes and criteria that characterize the supplier uniquely for them (e.g., supplier ID in the private database is the key to a set of other private attributes).

The DDM System has the capability for all public type information regarding suppliers to be codified using standards—D&B codes, GLNs etc that can be found in the global data dictionary as defined by EAN International and the Uniform Code Council (UCC).

In the Update Contact Information with respect to program step (110), a respondent may update their contact information upon request, such as by signing into the system, through an email (html), or in a web form triggered by an email with a URL. Finally, in the Deal with Inquiries Regarding Contact Request step 112, the DDM System enables the TC to send an email or web form request to the DO inquiring on the request and why it is needed etc.—from within the email or from a link or from a URL that can be used to get to the web form.

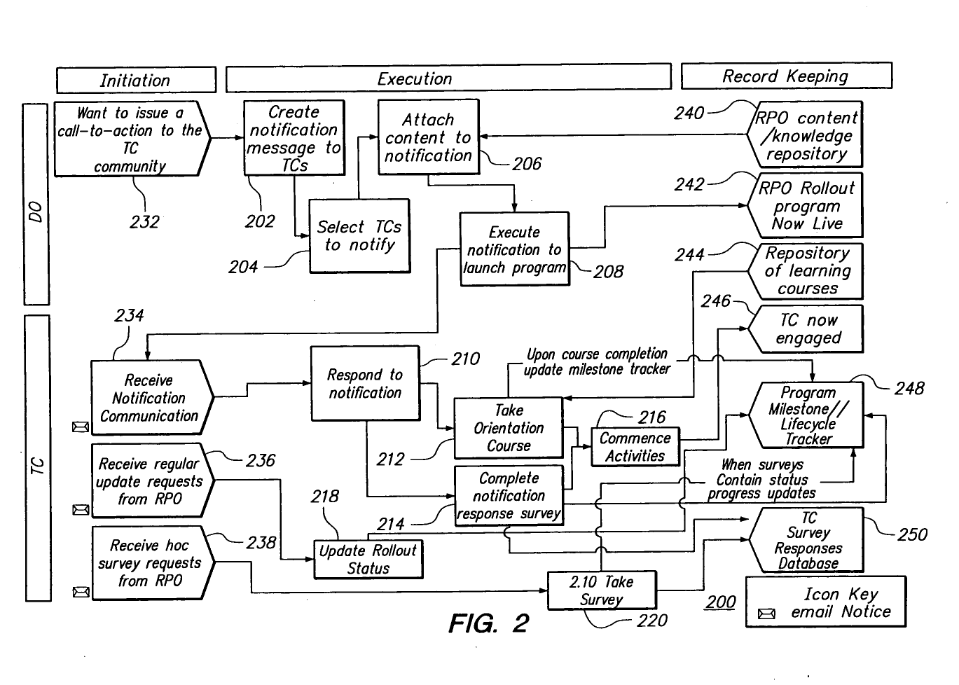

FIG. 2 is a flow diagram illustrating an implementation of an Execute Deployment Outreach Campaign process 200. Once the DO has set up their program and defined the community of TCs that they wish to deploy a project or program to, they are ready to launch an outreach campaign to launch the program. Subsequent to this they can continually communicate with the community in several ways to ensure that the program goes according to plan. These options include the ability to:
Conduct polls or surveys amongst all or specified groups/subsets of the community;
Offer c-learning courses to all or a specified subset or category of the community of TCs;
Create communities within their TCs so that they can enable peer-to-peer networking and shared learning, with bulletin boards, chat rooms and shared document repositories for knowledge assets that are associated with the program;
Allow the DO to get a key message out to the TCs and solicit feedback, confirmation, approval and/or advice.

The Outreach Campaign process includes the following sub-processes:
Create notification message to TCs (202)
Select TCs to notify (204)
Attach content to notification (206)
Execute Notification to launch program (208)
Respond to deployment notification (210)
Take Deployment Orientation Course (212)
Complete notification response survey (214)
Commence Deployment Activities (216)
Update Deployment Status (218)
Take Survey (220)

The deployment outreach campaign process 200 may correspond to a variety of initiation events, which may also be referred to as triggers or start events. For example, a DO may want to issue a call-to-action to the TC community (232). For example, when a retailer has set up their program in the first progress, they will be ready to commence. At any time they are ready they can begin their outreach program to one or many TCs.

Another initiation event is a Receive Deployment Notification Communication (234). When a DO has launched their program and the TC in question has been included within this deployment outreach campaign, then the TC(s) will receive a notification (typically within an email) from the DO.

Receive regular update requests from DO events (236) occur during a live deployment program, with the DO sending either automated or initiated requests (typically by email) to the TC(s) for regular status updates as to their progress.

Receive ad hoc survey requests from DO events (238) occur during any deployment program, with the DO choosing to conduct a survey amongst one or many TCs at will—the TCs will receive notifications that they have a survey to complete (via email) and the TC can go to or activate the survey from a link, URL or actually take the survey from within an email (if HTML form enabled).

The execution process steps are described further as follows. In step 202, a notification message to TCS is created. The DO preferably determines their communication messaging and strategy off-line. When they are ready to execute the notification, the DDM System is used to create the notification message that will be delivered in an email to the TCs. A variety of documents may be used to provide the message. For example, if the main message to the TCs is within a word document, PowerPoint presentation or another medium, the DDM System creates a cover message that references the attached document.

In Step 204, Select TCs to Notify, before or after creating a notification message, the DO defines the TC community for the notification. This may be their entire defined deployment universe of TCs or a sub set. For example, a Retailer may decide to notify all of their suppliers that they are launching a program (e.g., RFID) or they may have already done this before and are notifying a subset (e.g., just food suppliers) within this outreach. The TCs are selected either individually or in groups as defined in PROCESS I of this document, or with a “Select ALL” feature if the notification is going to all their contacts in the TC contacts database.

The DO may also attach 206 various content to outgoing campaign messages. The content may include any number of attachments. For example, the content may be an orientation course on the learning management system that they want the TC to take as a primer for the deployment, or it may be a graphic or other item.

Once ready to go live with the notification and the outreach campaign, the DO uses the DDM System to execute 208 a launch of the outreach campaign and move from the planning and defining stage to the execution stage. This will trigger sending the notification to all of the identified TCs who were targeted to get the notification, with optional read/receipt or delivery receipt. The notification may be sent in the form of an email that carries the message along with the content, or may be an email that instructs the TC to log into the DDM System to retrieve a message that is waiting for them.

In Respond to Deployment Notification (210), the TC needs to respond to the deployment or outreach notification from the DO. They will either do this by replying to the email they received or by logging into the DDM System and executing the response from there. The latter option may be more preferable so that the DDM System can track every response. For example, the e-mail may carry a “RESPOND” button in HTML, to send the TC to the right respond page in the DDM System for the notification, after logging in with username and password.

Steps 212 and 214 respectively entail the taking of courses and completion of surveys. Surveys and Courses are two different mechanisms. Surveys are to ask questions and obtain responses, whether they are to obtain the TC(s) readiness, interest, progress, infrastructure, technology, needs or whatever is deemed pertinent information by the DO issuing the survey. Courses are training and educational material created by the DO (potentially fully customized, but also based upon existing LMS courses) for consumption by TC(s) on either a mandatory or optional basis. The DO uses the DDM System to track and produce reports at individual TC level or group levels on survey and course status and corresponding information.

In Taking Deployment Orientation Course (212), for example, the DO may have stipulated in their deployment/outreach notification that they want the TC to take an orientation course or read a particular document that better explains the finer details of their request. As another example, a retailer may include in a notification an indication that any suppliers that they would be do RFID with must take an online orientation course on the retailer's requirements before they responded to the notification. This enables the supplier to know if they could respond positively or negatively to the notification, and to gauge how long it might take them to be ready for interacting with the retailer in the fashion described by the notification.

Completion 214 of the notification response survey may also be variously implemented. At the beginning of a major deployment campaign the DO will often want to ask the TC to respond to their deployment/outreach notification by taking a survey. The TC will receive an email notification with a link or button to launch the survey. After the TC logs into the DDM System and completes the survey and submits it to the DO, this will be their official response and a flag is sent to the milestone/tracker database that they have completed the survey. The results are sent to a database that provides analysis to the DO so they can see many different aspects of the TC's response. The information obtained from the TC will be used again and is thus linked to the TC's contact/unique ID in the public database but stored privately for that DO's deployment and that DO's TC database. For example, a supplier may get a 3 question survey that asks 1) if they will be able to meet a retailer's deadline for rolling out data sync 2) if they are a member of the global registry already and 3) whether they are already live or working with data sync with other retailers. This information can be stored and retrieved for reporting and to update the milestone tracker if one of the question responses provides key information that updates the milestone tracker.

In Commence Deployment Activities (216), the DO begins its own activities with respect to deployment. Deployment Status Updates (218) entails the TC receiving automated or ad hoc, DO-initiated requests for status regarding the program. The TC is allowed to log into the DDM System when this occurs to input status and answer status related survey questions or just answer the status questions asked within the body of an html/form based email.

The TCs take 220 the survey. The surveys are preferably online within the system. They are saved and submitted to the DO as desired.

Various repositories and reports are provided in relation to Deployment Outreach Campaign 200 as indicated under the Record Keeping column:

DO content/knowledge repository (240). The location on a disk/directory or within a database where the DO has stored key documents/files that contain information and knowledge regarding the deployment.

DO Deployment program Now Live (242). After the DO executes its notification, the deployment or particular outreach campaign will be live.

Repository of learning courses (244). The learning management system and it's repository of courses created by the DO.

TC now engaged (246). Once the TC has responded to a notification/outreach message from the DO or has completed a survey or course associated with the outreach, then the TC will be live and engaged in a program with that DO, and an indication of this status is retained by the DDM System.

Deployment Program Milestone//Lifecycle Tracker (248) is a database of key program milestones upon which to base progress monitoring and the Executive Dashboard views.

TC Survey Reponses Database (250) is a repository where survey responses are kept and retrieved for analysis and reporting.

The underlying functionality of the Deployment Outreach Process 200 is further described as follows. Create 202 notification message to TCs preferably accommodates defining a message that will go to one or many TCs—text format, free form—email format; sending HTML emails with buttons that the TC can click on to launch a survey or respond—that take the TC to the right page or section of the system after logging in with username and password; attaching any number of files to the message; attaching a multimedia show or file to the message; utilities such as spell checking of the message; and a mail merge function with support for addition of fields to a communication for creation of customized mass emails similar to a form letter, with the notification containing attributes specific to the deployment. For example, the notification might be a letter that mandates that 1000 suppliers begin implementing data synchronization with a retailer and that the supplier must be ready by a certain date—the first 100 suppliers may have one date, the next 500 may have a different date, and the final 400 may have yet another date—the DDM System will be able to look at the make up of the deployment dates by supplier/TC and enable this kind of customized communication—then the system can track the different deadlines by supplier type.

In selecting 204 TCs to notify, the DDM System accommodates browsing through the contact database by individual supplier, by groups of contacts or by ALL contacts, and selecting them for sending the notification message; tracking which message was sent to which TC(s), by date and type; specifying and providing a read/receipt or delivery confirmation mode; drag and drop contact(s) adding (e.g., in conjunction with Outlook) including copying to the master contacts repository and adding to the list of TCs to be notified.

In the attaching 206 content to notification step, the DDM System provides an ability to attach files of any size (or limited to a reasonable size, e.g., up to 25 Mb) to the notification; the ability to virus scan the attachments so that there is no risk to the TCs; and the ability to embed the content or link to the content in the email as a hyperlink or in an HTML email.

In connection with the execute 208 notification to launch program step, the DDM System allows for DO review of messages and formats before confirming and sending them, and allows the DO to submit the notification and confirm a status progression from “compose notification” to live.

Regarding respond to deployment notification (step 210), the DDM System provides the ability for the TC to reply to the email notification received from within the email (e.g., via HTML) or through provision of a URL that allows the recipient to launch the DDM System login page. The login may also be automatically accommodated such as through recognition using cookie information. The recipient is also preferably directed to the page in the DDM System corresponding to where the response for that DO is held. Responses may range from a simple “Yes” or “No” button based response, a survey, or a course that the TC must take for proper orientation to the outreach notification and the DO's requirements.

In support of taking 212 the deployment orientation course, the DDM System accommodates the ability for the TC to access a course that the DO wants them to take, which is similarly initiated by clicking on the notification email or copying an URL into a browser, followed by a login and navigation to the learning management area where the course is held, and then indicating completion of the course to notify the DO that the course has been taken.

For completion 214 of notification response survey, the DDM System supports sending the notification email to the TC, again including a link to a survey to be reviewed and completed by the TC, then submitted to the DO.

Commence Deployment Activities (step 216) may entail mostly offline activities conducted by DO in support of their actual deployment implementation.

In relation to Update Deployment Status (step 218), the DDM System allows the DO to send an email request to the TC(s) asking for a progress update against defined criteria—presenting the milestones to the TC and asking for a status against these milestones. This may be variously conveyed such as through a simple check box or radio button response, with check box being preferred where more than one criterion is submitted and linked to the milestone/lifecycle tracker. The DDM System also allows the DO to set automated requests for status out to the TC community against defined dates, periodicity and triggers. For example, the DO may configure the DDM System to automatically send email requests to all TCs or a specified subset of TCs every 2 weeks to inquire about a status request.

In support of taking 220 the survey, the DDM System allows TCs to take surveys with one or multiple questions. It also allows DO to construct and send surveys with different question types, such as through selection from drop down lists, multiple choice answers, open ended answers, rating scales, etc. Survey results are stored in a database that also links the responses to the TC contact information for enriching the private aspect of the contacts database for the DO and supporting subsequent retrieval for analysis and reporting.

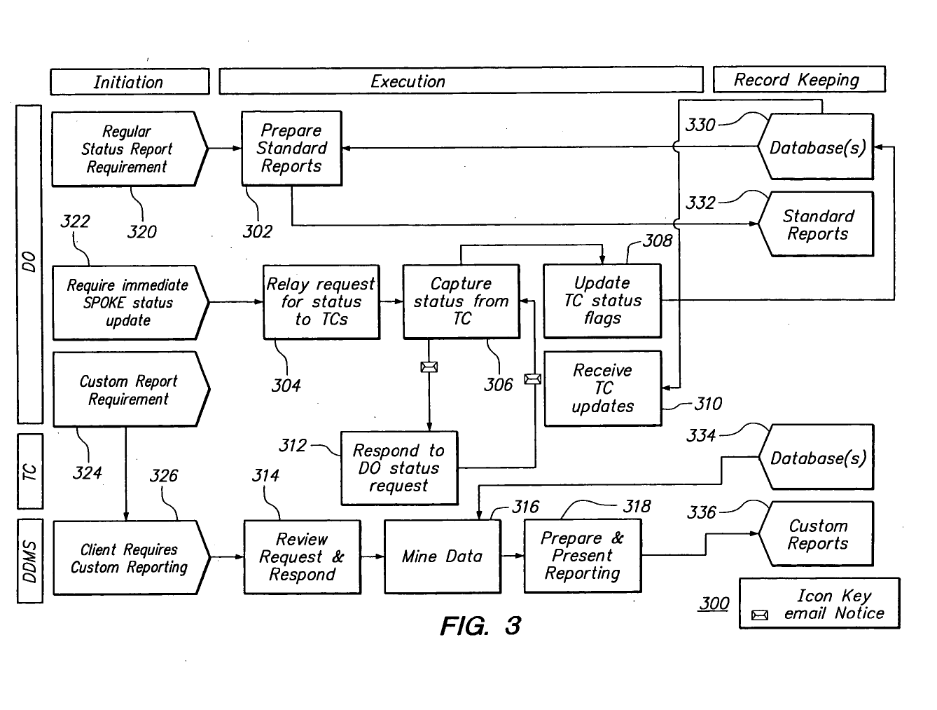

FIG. 3 is a flow diagram illustrating an overview of the Executive Dashboard process 300. For both the DO and TC, the Executive Dashboard acts as the central analytics and reporting function. DO program owners and TC program managers use the Executive Dashboard to gauge the success or failure for the deployment programs they organize and run using the DDM System. The Dashboard provides analytics and real-time reporting on a variety of program aspects, including:
Real-time TC engagement statistics;
TC pipeline for the program and status;
Drill-down capability enabling the user to investigate a number of levels of hierarchy of TCs to analyze their deployment program and understand the key drivers of momentum and barriers to successful deployment;
Customized reporting on TC progress and readiness and knowledge history;
An Executive Briefcase that enables most frequently used reports to be conveniently packaged for viewing and printing; and

Hot links to the DO or TC's chosen BI or reporting tools, such as for exporting data from the DDM System and performing analytics using their preferred solutions or in tandem with them.

The Execute Dashboard process includes preparing 302 Standard Reports, relaying 204 Request For Status To TCs, capturing 306 Status From TCs, updating 308 TC status flags, receiving 310 TC updates, responding 312 DO status request, request review and respond 314, mining data 316, and preparing and presenting 318 reports.

Initiating events are illustrated in the left-hand column of the flow diagram, and include Regular Status Report Requirement 320, Require Immediate TC status Update 322, Custom Report Requirement 324, and Client Requires Custom Reporting 326.

For Regular Status Report Requirement 320, DDM System users are able to access a standard set of reports that they use to monitor their key measures of performance—on a regular or ad hoc basis. In relation to Require Immediate TC status update 322, DO users may require their TC constituents to provide status reports or updates to the system that generate an updated report. For Custom Report Requirements 324, DO and TC users of the DDM System are able to generate customized reports. Regarding Client Requires Custom Reporting 326, the DDM System receives and supports responses to alerts by a system user regarding a need for custom report(s).

Execution of process steps for the Executive Dashboard are described as follows:

In support of preparing 302 Standard Reports, the DDM System provides users with standard reports that are typically used by the DO or TC users. The user is able to perform some self-customization and adjustment to these reports, but they are generally standardized reports that are required on a daily, weekly, monthly or other periodic basis. The DDM System leverages the various databases and draws from data collected from the TCs, the deployment program, the pipeline, milestone status, etc. Reports are generated in real time from queries provided by the DDM System, which may also accommodate the need for hard-copy and printable standard reports within a “My Briefcase” section.

If a DO user has a need for an immediate or more up to date status from a TC that is involved with them in a particular program, they may send 304 a request by email or via alert to the TC. If the request comes via email the TC will be able to respond in an HTML form within the email—if from an alert, then the DDM System will initiate an e-mail to the TC requesting the TC to log into their account to view and respond to the request.

In support of capturing 306 TCs status, the DDM system accommodates capture of a status update from the TCs via a form within an email or DDM System page.

The DDM System also allows TC status flags to be updated 308. After the TC has sent regular status updates or prompted updates, all the various status flags will be updated within the DDM System relational database. These will include flags that are generated automatically when a TC has met criteria tied to a particular milestone in the program plan defined for the program. For example, a store manager at Retailer may complete a training course that is loaded into the DDM System. Upon completion of the course, the system flags the progress of the TC (e.g., store manager in this example) and the system flag will update the progress pipeline.

In receiving 310 TC(s), the DDM System preferably aggregates responses captured from the TCs and writes them to the appropriate tables within the DDM System database, together with metadata regarding the particular TC/DO/PROGRAM in question. In responding 312 to DO status requests, the TC responds to the DO's request for a status update by taking action within the system or in an email generated by the system. In reviewing and responding 314 to requests, the DDM System may optionally have support personnel receive and review requests for custom reporting from DO and TC customers and respond accordingly. Default responses to particular questions may also be implemented.

Data mining 316 is undertaken in support of customized reporting, wherein the DDM System database(s) are minded for information that is presented in the reports. Finally, reporting 318 provides custom reports are either stored in the system as standard reports from that point on or are sent to the customer as ad hoc or one-off paid for reports.

Results corresponding to the Execute Dashboard functionality include Deployment Database(s) 330, 334, Standard Reports 332, and Custom Reports 336.

The Deployment Databases 330, 334 include the main tables regarding the DDM System CRM, Milestone, Pipeline and transactional information generated by users.

Standard Reports 332 are those that have been set up as queries that present on-screen and printable reporting. These include:
Overall status % bar for completion of the project as defined by the DO program owner or TC program owner;
Program adoption or progress by TC group or type;
Overall adoption pipeline for all TCs from program start to completion;
Summary of TC adoption by milestone (with drill down capability);
Problem Areas—longest milestones to complete by TCs and groups;
Deployment forecast and projections based on historic adoption and TC adoption pace;
TC category comparison—type of TC versus rate of adoption;
Drill down at any level of TC hierarchy to L—Live, I—Implementing, NA—Not Active, NR—Not responded, H—On hold;
Incoming programs report for TCs—all programs; and

Drill down for TCs to view customer or DO incoming program progress.

Custom Reports 336 are generated from data in the system that are not part of the standard, default reporting queries.

Additional processes related to the described execution process are as follows.

In support of preparing 302 Standard Reports, the DDM System presents the following report types in different views and drill down capable presentations: 1. Overall status % bar for completion of the project as defined by the DO program owner or TC program owner; 2. Program adoption or progress by TC group or type; 3. Overall adoption pipeline for all TCs from program start to completion; 4. Summary of TC adoption by milestone (with drill down capability); 5. Problem Areas—longest milestones to complete by TCs and groups; 6. Deployment forecast and projections based on historic adoption and TC adoption pace; 7. TC category comparison—type of TC versus rate of adoption; 8. Drill down at any level of TC hierarchy to L—Live, I—Implementing, NA—Not Active, NR—Not responded, H—On hold; 9. Incoming programs report for TCs—all programs; 10. Drill down for TCs to view customer or DO incoming program progress. It also provides the ability to save reports to a Briefcase and access them quickly for viewing and printing, the ability to use system tools for the user to generate their own custom reports, and links to popular applications such as Crystal, Cognos and new data visualization vendor applications or objects.

In support of relaying 304 requests for status to TCs, the DDM System allows DO to select the TC(s) they want to contact for status updates and then confirm before sending; allows the DO to send a status capture e-mail that contains an embedded HTML form for capture of status against the specific program milestones; and allows the DO to prompt the alert system to generate an e-mail calling for TC users affected by the alert or request for status to log into the system and perform a specific action.

In support of capturing 306 status from TCs, the DDM System provides the ability for the system to capture the data updates and status updates from the TCs or HUBS and write it to the appropriate tables within the database.

In updating 308 the TC status flags, the DDM System supports status update(s) provided by the TC to update the milestone tracker table and to post progress to the deployment database that may subsequently be queried business intelligence or program status. It also picks up status flags and data from TC progress through individual or multiple training courses for status that links their involvement in a training course to a program, and links surveys taken by users to status flags and milestone completion or to enrich milestone completion reports that are drilled-down.

Finally, Receive TC Updates 310 includes the ability to receive updates via the system after the user has logged in and the ability to receive updates in HTML forms embedded within emails, and data mining 316 includes support for consultant data mining against custom report requirements of the customer, as well as the ability to store finished data mining reports in the system for easy retrieval as part of the Executive Dashboard or briefcase within the reporting function.

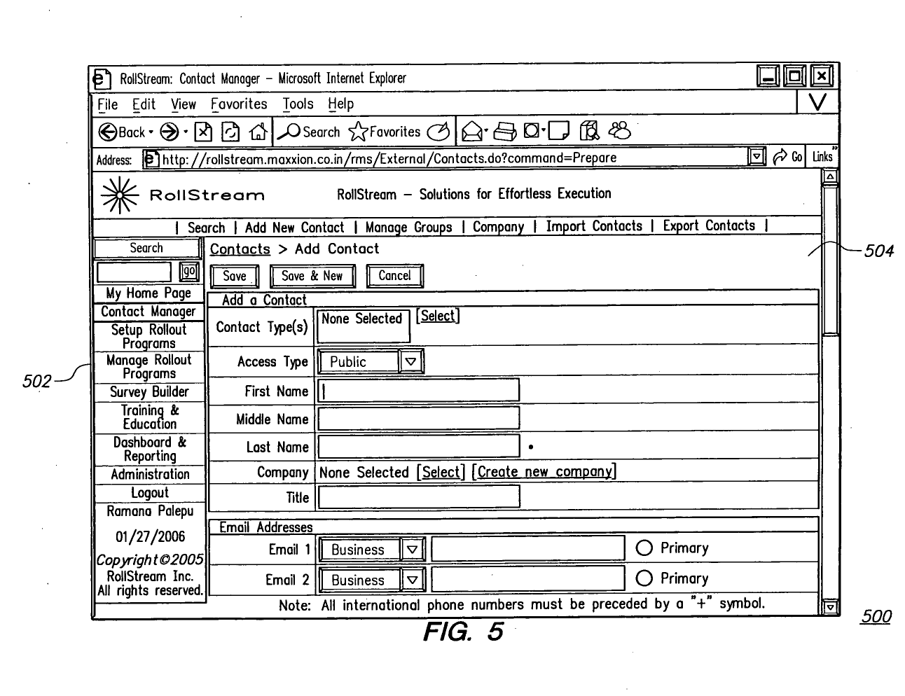

The user interface that accommodates the above-described functionality is still another aspect of the present invention. FIGS. 5-10 are display diagrams variously illustrating an example of the user interface for accommodating the functionality described above. The user interface can be browser based and accommodates entry and receipt of information through displays and corresponding input such as via conventional keyboard and cursor based operations.

FIG. 5 is a display diagram illustrating an example of a user interface for adding a contact 500. The user interface 500 includes a navigational panel 502 that is generally persistent to provide the user with an overview of the functional categories and offer immediate initiation of a particular category. The navigational panel 502 categories include My Home Page, Contact Manager, Setup Deployment Programs, Manage Deployment Programs, Survey Builder, Training & Education, Dashboard & Reporting, and Administration. Selection of any category prompts display of corresponding information in the main panel 504 next to the navigational panel. The main panel may include a header row which allows selection of an item within the current category, and/or tabs within the main panel page to do the same and provide additional navigation within the current category. In FIG. 5, the Contact Manager is active, and the Add New Contact item within that category is active such that a panel for entering information for a new contact is displayed. Contacts may also be searched, groups of contacts may be managed, and contacts may be imported and exported under the My Contacts category.

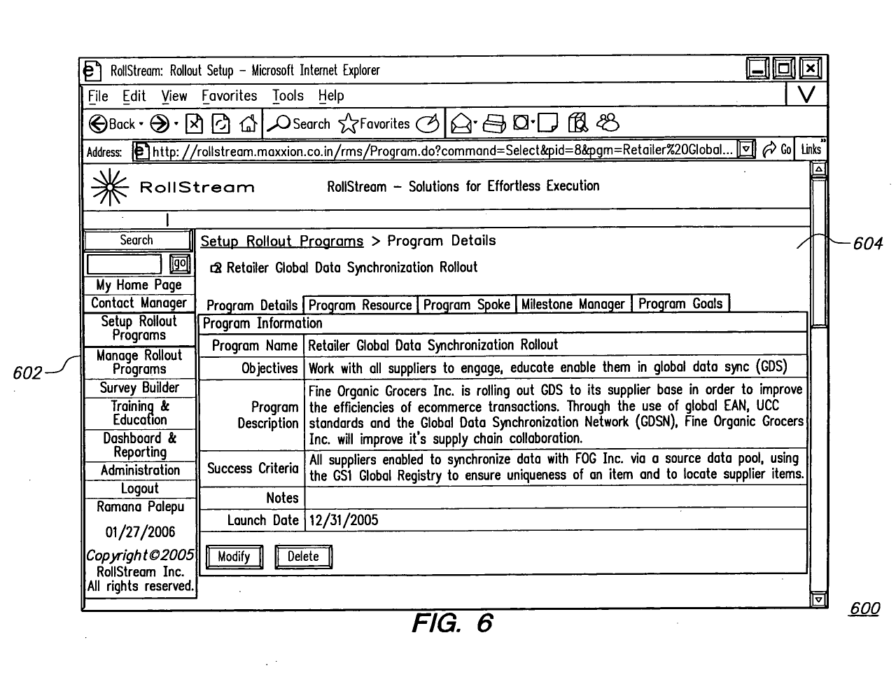

FIG. 6 is a display diagram illustrating an example of a user interface for creating a new program 600, corresponding to initiation of Setup Deployment Program. This interface similarly includes a navigational panel 602 and main panel 604. As illustrated, program details may be added, modified and deleted, including information such as the name of the program, objectives, success criteria, launch date, etc. Within this category, program resource, program TC, milestone manager and program goals are also selected and managed, in the fashion described above. For example, a DO may view and add TCs to the program, and may view and manage milestones and corresponding alert settings.

The creation of the new program may be fully customized, or may be based upon a template. Where a template is used, it may be a template that is particular to the industry or type of program, and it may be fully adopted or further customized by the user.

In the Manage Deployment Programs category, the user (DO) may setup a campaign within a program, select TCs for the campaign, such as by type or company, and prepare notices that may further include attached documents, surveys and training courses.

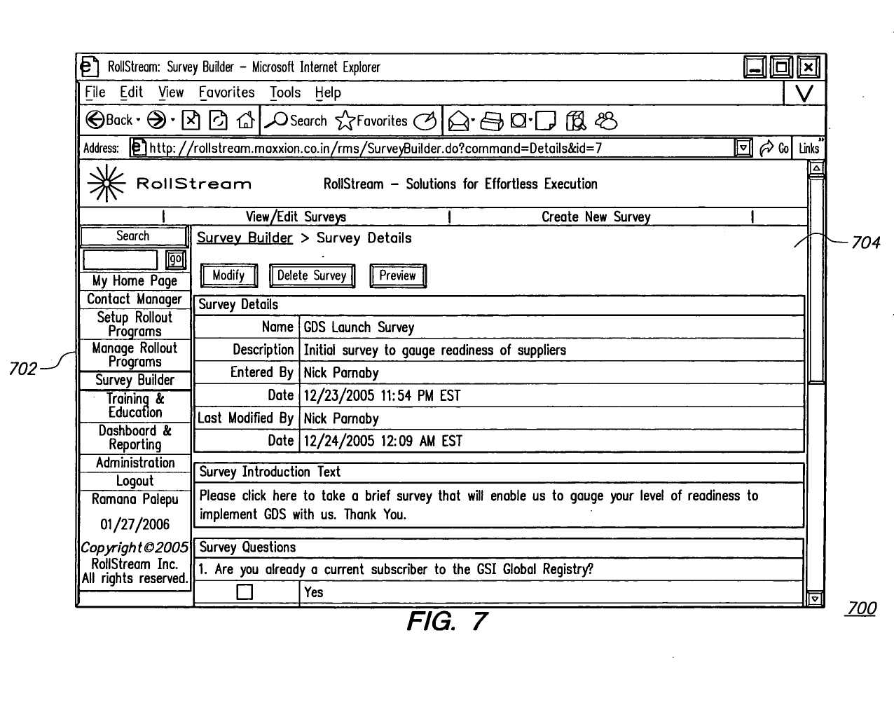

FIG. 7 is a display diagram illustrating an example of a user interface for creating and editing a survey 700, including respective navigation 702 and main 704 panels. This display is prompted by selection of the Survey Builder category and corresponding initiation of the “Create New Survey” task. Information including details of the survey, the text to be used in introducing the survey, and the corresponding questions is entered for the new survey. The list of surveys for the program may also be viewed by initiating the view/edit surveys mode, and selecting a given survey from the list, whereupon the survey information is displayed for the given survey.

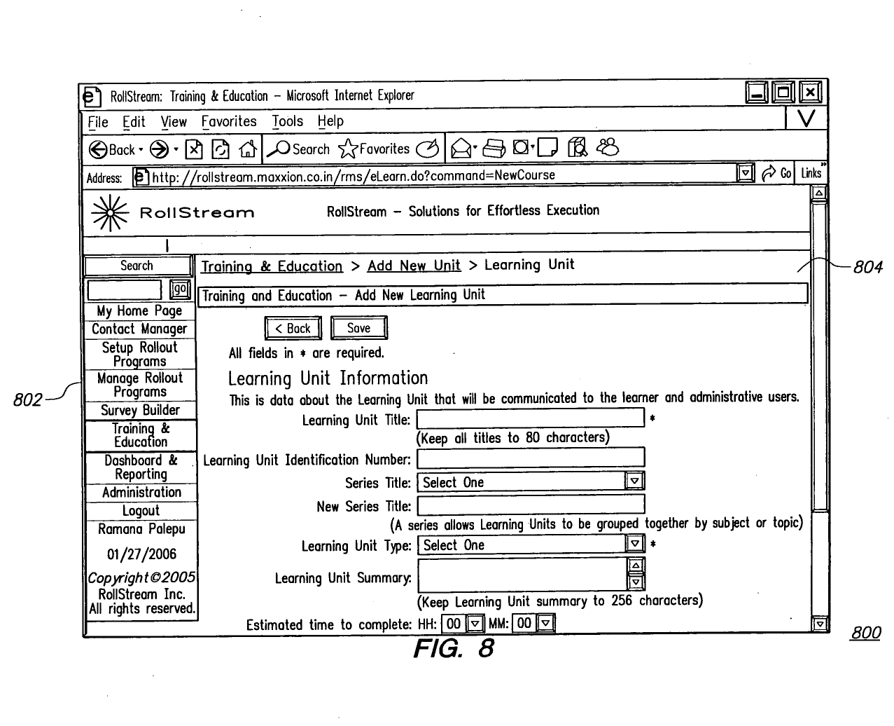

FIG. 8 is a display diagram illustrating an example of a user interface for adding a new training and education unit 800, including respective navigation 802 and main 804 panels. This interface 800 corresponds to the Training & Education Category. In this category, courses may be created and managed. FIG. 8 illustrates some of the fields used to add a new unit. Lists of all available learning units may also be viewed together, with links to particular units offering additional information.

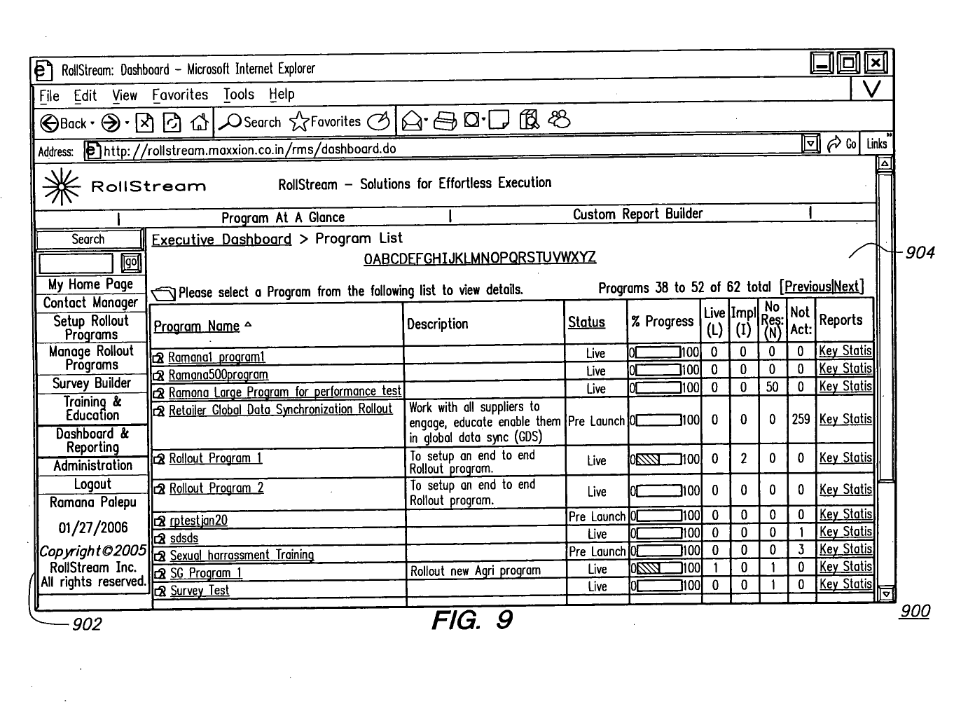

FIG. 9 is a display diagram illustrating an example of an executive dashboard user interface 900, similarly including the persistent navigation panel 902 and corresponding main panel 904 that is displayed by selection of the Dashboard & Reporting category. In the main panel, a program list displays the program names and corresponding description, status, % progress, and reports information. The program name and other information provides links to additional information.

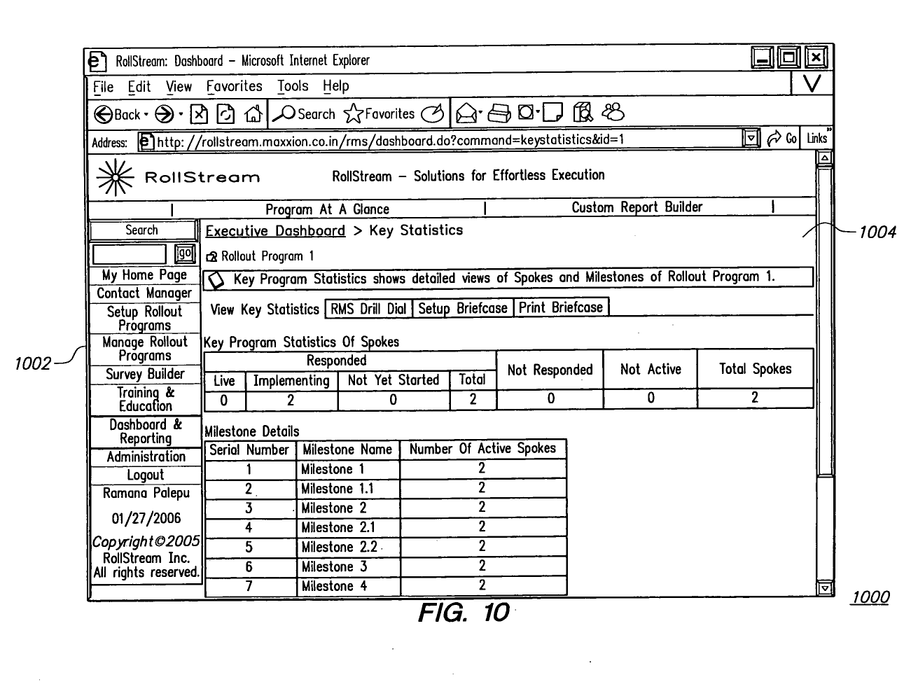

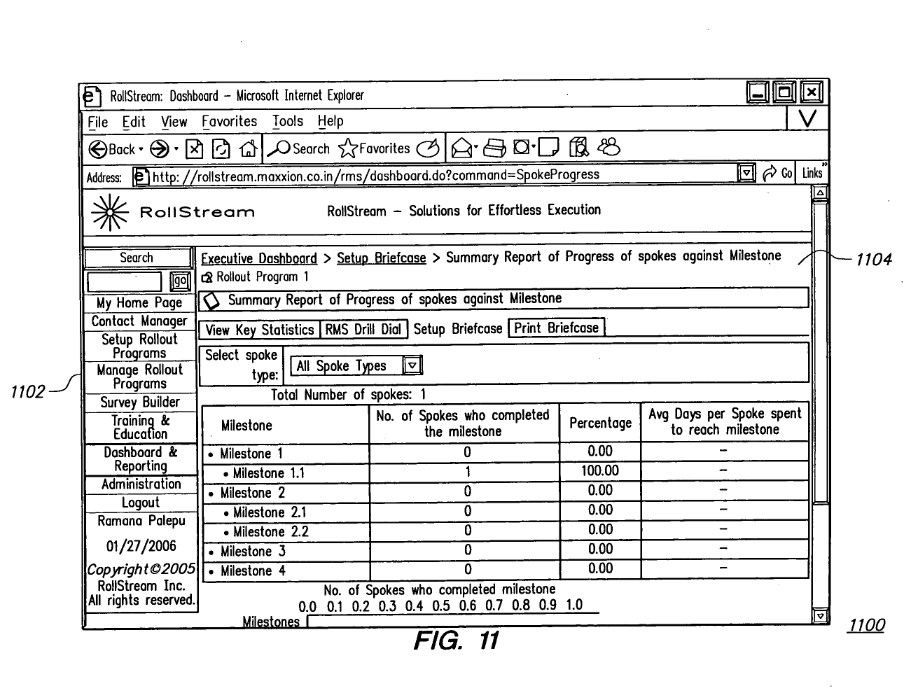

FIG. 10 is a display diagram illustrating an example of an executive dashboard user interface 1000, 1002, 1004 with further illustration of key statistics for a selected program “Deployment Program I”, which is one possible selection from the main panel as previously described. Within the program, Key Statistics, Drill Dial, Setup Briefcase and Print Briefcase may be selected. As illustrated in the figure, Key Program Statistics of TCs and Milestone Details are listed for the program. The Drill Dial allows identification and provision of additional information about particular TCs and corresponding status, completion and milestone information. FIG. 11 is a display diagram illustrating an example of a user interface 1100 where the Briefcase is selected, which lists milestones, the number of TCs completing each milestone, the corresponding percentage for that number, and information such as the number of days to completion of the milestone on a per TC basis.

Selection of the Administration category allows various system configuration and administration, roles management (e.g., DO, TC, etc.), role permissions set ups, and other such features as previously described.

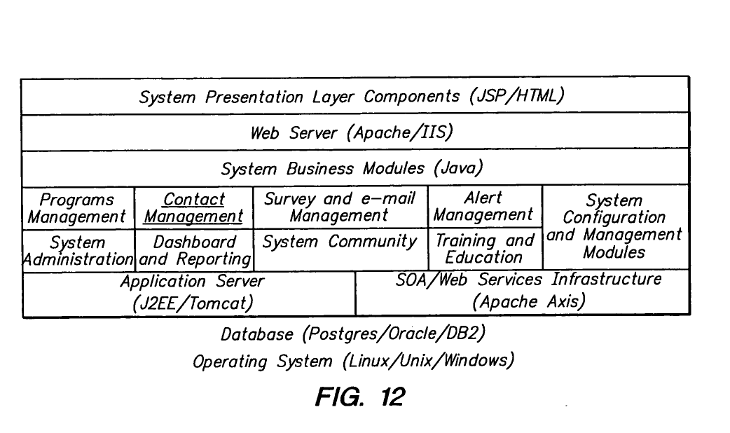

FIG. 12 is a block diagram illustrating an example of the software system architecture for the DDM System. The DDM system modules include Contact Management, Dashboard and Reporting, Survey and E-Mail Management, DDM System Community, Alert Management, Training and Education. These modules respectively operate to provide the functionality described above in relation to contacts management, reporting, surveys, education, e-mail management, training & education, and the presentation of alerts. The System Administration and DDM System Configuration and Management Modules may be accessed by a system administrator for the platform, to provide overall management of the system for all DO and TC participants, to update services, troubleshoot, and the like. The Deployment Program Management module provides the management of deployments and related features, and as such communicates with the remaining modules to carry out the described processes of deployment management. An example of a DPM module has been described further above, with reference to FIG. 13. in relation, and RM System Configuration and Management Modules. Any conventional platform and corresponding database architecture may be used, including but not necessarily limited to Linux, Unix, Windows, and other operating systems, and Postgres, Oracle and DB2 databases. Additionally, any conventional hardware, communication protocols, and languages may be provided for providing the server architecture and corresponding interfaces with the DO, TC and other parties accessing and interacting with the DDM System.

Thus embodiments of the present invention produce and provide distributed deployment management. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for managing distributed deployments, the method comprising:
defining a deployment program having a deployment schedule, a plurality of participation events, and a plurality of target constituents each being associated with at least one participation condition in the deployment program, the participation condition being based upon at least one participation event from the plurality of participation events;
segmenting the plurality of target constituents, such that sets of one or more target constituents are respectively members of different segments;
sending a deployment announcement message to the plurality of target constituents; and
engaging the plurality of target constituents to further an execution of the deployment program according to the deployment schedule, with the participation conditions for respective target constituents differing based upon segment membership.

2. The method of claim 1, wherein segmenting provides a wave-based distributed deployment, with an initial segment defining an initial target constituent community that initially completes at least one participation event in the deployment schedule, and at least one successive segment defining successive target constituent communities that subsequently complete at least one participation event in the deployment schedule.

3. The method of claim 2, wherein sending the deployment announcement message comprises initially announcing the deployment to target constituents in the initial segment and subsequently announcing the deployment to target constituents in the at least one successive segment.

4. The method of claim 1, wherein segmenting further comprises:
receiving participant community attribute information;
defining a particular segment of the plurality of target constituents based upon the received participant community attribute information; and
engaging with the particular segment of the plurality of target constituents to further the execution of the deployment program.

5. The method of claim 4, wherein receiving participant community attribute information comprises receiving a query related to completion of a selected participation event in the deployment schedule, with the particular segment being defined as those target constituents that have not yet completed the selected participation event.

6. The method of claim 4, wherein the participant community attribute information includes target constituent company type, name, location, title, participation event completion status, access rights status, technology capability.

7. The method of claim 4, wherein receiving participant community attribute information comprises receiving a response to a survey question, with the particular segment being defined as those target constituents that indicate a given response to the survey question.

8. The method of claim 1, wherein the deployment program involves a document sharing between the deployment owner and the plurality of target constituents, and segmenting defines access rights corresponding to a document involved in the document sharing.

9. The method of claim 9, wherein the document is partitioned for viewing, with segmenting dictating which portions of the document can be viewed, such that a first target constituent can view only a first portion of the document, and a second target constituent can view only a second portion of the document.

10. The method of claim 1, wherein the deployment program is one of a technology rollout, retail display rollout or technology rollout.

11. The method of claim 1, further comprising:
reporting progress relating to the execution of the deployment program, wherein reporting includes providing analytics corresponding to completion of the defined participation for the plurality of target participants as a group and for subsets of the plurality of target participants.

12. The method of claim 1, wherein the deployment program and corresponding characteristics are initially defined from a library of reusable templates.

13. The method of claim 1, wherein the reusable templates define deployment programs that include one or more of survey materials, training materials, tasks, and documents, and a corresponding deployment schedule.

14. A system for organized management of distributed deployments, the method comprising:
means for defining a deployment program having a deployment schedule, a plurality of participation events, and a plurality of target constituents each being associated with at least one participation condition in the deployment program, the participation condition being based upon at least one participation event from the plurality of participation events;
means for segmenting the plurality of target constituents, such that sets of one or more target constituents are respectively members of different segments;
means for sending a deployment announcement message to the plurality of target constituents; and
means for engaging the plurality of target constituents to further an execution of the deployment program according to the deployment schedule, with the participation conditions for respective target constituents differing based upon segment membership.

15. The system of claim 14, wherein the means for segmenting provides a wave-based distributed deployment, with an initial segment defining an initial target constituent community that initially completes at least one participation event in the deployment schedule, and at least one successive segment defining successive target constituent communities that subsequently complete at least one participation event in the deployment schedule.

16. The system of claim 14, wherein the means for segmenting receives participant community attribute information, defines a particular segment of the plurality of target constituents based upon the received participant community attribute information, and the means for engaging engages with the particular segment of the plurality of target constituents to further the execution of the deployment program.

17. The system of claim 14, wherein the deployment program involves a document sharing between the deployment owner and the plurality of target constituents, and segmenting defines access rights corresponding to a document involved in the document sharing.

18. The system of claim 14, wherein the deployment program and corresponding characteristics are initially defined from a library of reusable templates, wherein the reusable templates define deployment programs that include one or more of survey materials, training materials, tasks, and documents, and a corresponding deployment schedule.

19. An apparatus for organized management of distributed deployments, the apparatus comprising:
a deployment program definition module, which defines a deployment program having a deployment schedule, a plurality of participation events, and a plurality of target constituents each being associated with at least one participation condition in the deployment program, the participation conditions being based upon at least one participation event from the plurality of participation events;
a segment management module, in communication with the deployment program definition module, which segments the plurality of target constituents, such that sets of one or more target constituents are respectively members of different segments; and
a deployment execution module, in communication with the segment management module and the deployment program definition module, which sends a deployment announcement message to the plurality of target constituents and engages the plurality of target constituents to further an execution of the deployment program according to the deployment schedule, with the participation conditions for respective target constituents differing based upon segment membership.

20. The apparatus of claim 19, wherein segmenting provides a wave-based distributed deployment, with an initial segment defining an initial target constituent community that initially completes at least one participation event in the deployment schedule, and at least one successive segment defining successive target constituent communities that subsequently complete at least one participation event in the deployment schedule.

21. The apparatus of claim 19, wherein the segment management module receives participant community attribute information, defines a particular segment of the plurality of target constituents based upon the received participant community attribute information, and the deployment execution module engages with the particular segment of the plurality of target constituents to further the execution of the deployment program.

22. The apparatus of claim 19, wherein the deployment program involves a document sharing between the deployment owner and the plurality of target constituents, and segmenting defines access rights corresponding to a document involved in the document sharing.

23. The apparatus of claim 19, wherein the deployment program and corresponding characteristics are initially defined from a library of reusable templates, wherein the reusable templates define deployment programs that include one or more of survey materials, training materials, tasks, and documents, and a corresponding deployment schedule.

24. A method, comprising:
receiving a plurality of deployment program indicators to define a deployment schedule and a plurality of participation conditions;
receiving a plurality of target constituent indicators, each target constituent indicator from the plurality being associated with a target constituent from a plurality of target constituents;
segmenting the plurality of target constituent indicators to produce a first subset of target constituent indicators and a second subset of target constituent indicators, the first subset of target constituent indicators being associated with at least one participation condition from the plurality of participation conditions, the second subset of target constituent indicators being associated with at least one participation condition from the plurality of participation conditions; and
sending a message to the plurality of target constituents such that a deployment program is executed based on the deployment schedule, the at least one participation condition associated with the first subset of target constituent indicators and the at least one participation condition associated with the second subset of target constituent indicators.

25. A method, comprising:
receiving a plurality of deployment program indicators to define a deployment schedule, a plurality of participation events and a plurality of participation conditions;
receiving a plurality of target constituent indicators, each target constituent indicator from the plurality of target constituent indicators being associated with a target constituent from a plurality of target constituents;
sending a message at a first time to a first subset of target constituents from the plurality of target constituents based on at least one participation condition from the plurality of participation events and associated with the first subset of target constituents;
receiving a message from the first subset of target constituents indicating that a first participation event from the plurality of participation events has been completed based on a deployment schedule;
sending a message at a second time to a second subset of target constituents from the plurality of target constituents based on at least one participation condition from the plurality of participation events and associated with the second subset of target constituents; and
receiving a message from the second subset of target constituents indicating that a second participation event from the plurality of participation events has been completed based on the deployment schedule.
